(19) United States
(12) Patent Application Publication
(10) Pub. No.: US 2009/0029836 A1
(43) Pub. Date: Jan. 29, 2009

(54) AUTOMATIC FEED-THROUGH SHAPE AND SAND MACHINE

(76) Inventor: Adam Britton, Chico, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/174,719

(22) Filed: Jul. 17, 2008

Related U.S. Application Data
(60) Provisional application No. 60/950,302, filed on Jul. 17, 2007.
(60) Provisional application No. 60/950,332, filed on Jul. 17, 2007.

(51) Int. Cl. B23Q 3/157

(52) U.S. Cl. 483/1; 483/55

(57) ABSTRACT

A method and apparatus for quickly changing CNC machine tools is presented. Tool changes of 40 seconds or less are possible. A tool repository of linearly spaced apart tool forks translates to a storage position for CNC machining operations. For tool changing, the tool repository translates to a staging location, where an existing tool may be deposited to an empty location in the tool repository, whereupon another tool may be selected and engaged on the CNC machining spindle. The tool repository retracts to a storage position, and CNC machining operations may continue. This design may be used for CNC machines with many additional axes of operation, and appears more compact, less expensive, more robust, and lighter that traditional turret carousel designs. Stacked tools 5 inches high and diameters of 8 inches may be used in one embodiment. In the same space 15 smaller tools of 1.5 inch diameter may be stored.

### CROSS-REFERENCE TO RELATED APPLICATIONS

This application claims priority to U.S. provisional patent applications 60/950,302, filed Jul. 17, 2007, and 60/950,332, also filed Jul. 17, 2007, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to automatic tool changers, more particularly to Computer Numerical Controlled (CNC) automated tool changers, and still more particularly to translational automated tool changers.

2. Description of Related Art

Automatic tool changers are found on a variety of CNC devices. Such tool changers are used to exchange one tool for another in a sequence of operations used to form processed parts during a sequence of CNC operations. Generally, such tool changers are mounted on a rotational platform, which are rotated on a carousel to allow for tool placement and removal.

Traditional tool changers in computer numerically controlled (CNC) automated machining devices in the past have been either been very bulky, or inordinately complex. The bulky designs typically utilize circular (referred to as “turrets”) tool mounting storage locations (referred to as “carousels”) for three or more machine tools. Turret based carousel tool changers usually are not well integrated into the overall design of the CNC device, and tend to make the overall footprint of the combined CNC larger.

Other, more complex tool changing designs may utilize articulated intermediary tool transport mechanisms that, due to their complexity, may be more likely to fail, as well as more expensive, than simpler devices. Such articulated carousel changers attempt to keep the resulting CNC device somewhat controlled in size at the expense of complexity.

Traditional tool changer designs for consist of turret systems. Such systems typically comprise three or more tools are mounted on a carousel that will rotate to the desired tool to be grabbed by the spindle. Most of these designs are large in size and consequently lead to more expensive manufacture.

### BRIEF SUMMARY OF THE INVENTION

An aspect of the invention is a tool changer that comprises: a CNC machine comprising a spindle; a tool repository, comprising a plurality of tool forks; one or more machine tools held by corresponding tool forks; and means for transferring a specified tool between one of the tool forks and the spindle.

The means for transferring the specified tool may comprise: a slider rod mounted to one end to the CNC machine; a slider block that translates on the slider rod, wherein the slider block and the tool forks are affixed to a tool changer frame; and an actuator that has attachment points to the CNC machine and to the slider block, that allows translational actuation of the tool changer frame relative to the CNC machine.

In another aspect of the invention, a slider block may be mounted to the CNC machine, and a slider rod may be affixed to a tool changer frame.

The slider block may comprise a translation, or translating member, with a possibility of rotation. In this embodiment, there are two degrees of freedom of the slider block: translation and rotation. Without limitation, such could be accomplished by using a set of roller bearings disposed against a cylindrical slider rod.

The slider block may also comprise a translation with substantially no possibility of rotation. In this embodiment, there is only one degree of freedom, that of axial translation. Without limitation, such a slider block may be constructed of sets of three or more roller bearings translating upon a projected triangular slider rod, or a single slider rod comprising a non circular cross section with mating races, so as to preclude rotation.

Frequently, two slider blocks are affixed to the tool changer frame to allow for a translational motion without any potential rotational component.

The tool changer frame may comprise a plurality of tool forks disposed along the tool changer frame in a substantially linear fashion. Alternatively, the tool forks may be disposed in any other fashion, so long as the locations of the tool holder receiving area are known. Additionally, large tools may be interspersed amongst smaller tools to increase the overall density and utility of the tool repository for specific routine CNC machining operation sets.

The tool fork may comprise a spring loaded ball partially protruding into a tool holder receiving area. One of the least expensive and most reliable forms of ball is a simple stainless steel ball bearing. The tool fork may comprise a ridge in a tool holder receiving area that mates with a corresponding groove in the tool fork so as to removably retain the tool holder. Typically, such ridge and groove are formed in a plane normal to the tool changer frame, although other, non-normal orientations are possible. Still other variations may comprise a plurality of such ridges and grooves.

In another aspect of the invention, the tool fork may comprise one or more grooves in a tool holder receiving area that mates with corresponding ridges in the tool fork. The orientations of these grooves and ridges may similarly be in a plane normal to the tool changer frame.

The tool changer CNC machine may have axes of motion (of its rotary spindle) selected from a group of axes consisting of: 2 axes, 3 axes, 4 axes, 5 axes, 6 axes, and more than 6 axes. These correspond to traditional 2 axis, 3 axis, 4 axis, 5 axis, 6 axis, and more than 6 axis CNC machines. Generally these axes refer to an axis of motion of the CNC head, or spindle, and encompass X, Y, Z spatial positioning axes, as well as pitch, roll, and yaw of the spindle. For CNC machines of greater than 6 axes, there are redundant, non-linearly-independent axes present. The rotation of the CNC spindle is generally not included in the count of axes.

Another aspect of the invention may include a method of tool changing that comprises: providing a translating tool changing assembly, (comprising one or more tool forks mounted to a tool changing frame); actuating the translating tool changing assembly causing at least one of the tool forks to move out to a staging translation; and moving the CNC motor (comprising a rotary spindle) so as to removably engage a tool holder (that mounts a machine tool on the rotary spindle) within a tool fork, forming an engagement between the tool holder and the tool fork. The movement of the translating tool changing assembly and the CNC motor may be simultaneous or sequential in any order.

The engagement may comprise a mechanical feature in the tool holder and a reciprocally matching mechanical feature in the tool fork.

In one aspect of the invention, the mechanical feature in the tool holder is a recess forming a groove; and the mechanical feature in the tool fork is a ridge.

In an alternative aspect of the invention, the mechanical feature in the tool holder may be a ridge; and the mechanical feature in the tool fork may be a recess forming a groove. The groove may be proprietary to the HSK or NMTB tapers.

The method of tool changing may further comprise: releasing the tool holder from the CNC spindle; separating the CNC spindle away from the tool holder; and retracting the translating tool changing assembly causing the tool forks to move to a storage location; thereby storing the tool in the tool changing assembly. It should be noted that the tool holder is a mounting device whereby a machine tool actually used for a machining operation is mounted. The tool holder may be permanently or removably mounted to the machine tool.

The method of tool changing may further comprise: retaining the tool holder to the spindle; then moving the spindle away from the tool fork; and retracting the translating tool changing assembly causing the tool forks to move to a storage location; thereby loading the machine tool onto the spindle to form a loaded spindle.

The method of tool changing may comprise: moving the loaded spindle to a working location; and continuing CNC machining operations with a machine tool mounted on tool holder retained on the loaded spindle.

An apparatus may be capable of performing the method steps described above.

A product may be also produced by processed described above, through a sequence of machining operations using one or more machine tools mounted on their respective tool holders.

In a still another aspect of the invention, a computer readable medium may comprise a programming executable capable of performing on a computer the methods described above. Although not discussed here in any depth, each CNC machine axis is under computer control, as is the rotation and speed of rotation of the spindle. The steps for changing tools forms a sequence of computer steps whereupon the individual component axes and spindle of the CNC machine are directed to move to particular locations, and to perform particular functions. Here, actuation of the tool repository from its tool storage location to its tool staging area is another set of CNC steps. With proper computer coding, the detailed motions involved in storing, loading, and exchanging machine tools are very straightforward.

Further aspects of the invention will be brought out in the following portions of the specification, wherein the detailed description is for the purpose of fully disclosing embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIGS. 1A-1F depict, without limitation, movements required to exchange tools with a translational tool changer mounted on a feed-through CNC shaping/sanding machine.

FIG. 1A is a perspective view of a translational tool changer mounted on a feed-through CNC shaping/sanding machine, where the CNC motor is disposed in an operational position ready to do work with an active machine tool.

FIG. 1B is a perspective view of a translational tool changer mounted on a feed-through CNC shaping/sanding machine, where the CNC motor has moved upward in preparation of depositing the active machine tool in an empty tool fork storage position within the tool repository.

FIG. 1C is a perspective view of a translational tool changer mounted on a feed-through CNC shaping/sanding machine, where the CNC motor is disposed in a position where the formerly active machine tool has been placed for storage in the tool repository.

FIG. 1D is a perspective view of a translational tool changer mounted on a feed-through CNC shaping/sanding machine, where the CNC motor is now shown with no tool mounted to the CNC spindle. This step is shown to clarify that there is a point in the tool changing operation where the CNC spindle does not have a tool, and the tool changer has been retracted.

FIG. 1E is a perspective view of a translational tool changer mounted on a feed-through CNC shaping/sanding machine, where the CNC motor is disposed in a position where a new active machine tool has been mounted to the CNC spindle.

FIG. 1F is a perspective view of a translational tool changer mounted on a feed-through CNC shaping/sanding machine, where the CNC motor is disposed in an operational position ready to do work with the newly exchanged active machine tool, and the tool changer has been retracted.

FIG. 2 is a an perspective view of three major components of the translational tool changer mounted on a feed-through CNC shaping/sanding machine, showing: 1) the basic CNC feed-through machine, 2) the tool repository, and 3) the protective cover that mounts onto the tool repository.

FIG. 3A is a perspective view of a translational tool changer tool fork that removably receives and stores machine tools that have tool holder mounts as shown in FIG. 3B.

FIG. 3B is a perspective view of an active or stored machine tool mounted on a tool holder. The tool holder allows for automatic CNC machine mounting, as well as for storage within the tines of the tool fork of FIG. 3A.

FIG. 4A is a perspective view of a translational tool changer of a CNC feed through shaper/sander, where the dust collector is shown open for removal or replacement of an active tool.

FIG. 4B is a perspective view of a translational tool changer of a CNC feed through shaper/sander, where the dust collector is shown closed around the active machine tool for dust removal.

FIG. 5A is a perspective view of a translational tool changer of a CNC feed through shaper/sander, such as the Voorwood A1515 CNC Shaper/Sander, Voorwood Company, 2350 Barney Street, Anderson, Calif. 96007, showing two machining bays, each with two CNC spindles with associated two tool repositories.

FIG. 5B is a perspective view of a right-handed translational tool changer of a CNC feed through shaper/sander, such as the Voorwood A1515 CNC Shaper/Sander, Voorwood Company, 2350 Barney Street, Anderson, Calif. 96007, showing a variety of machine tools stored in the tool repository.

### DETAILED DESCRIPTION OF THE INVENTION

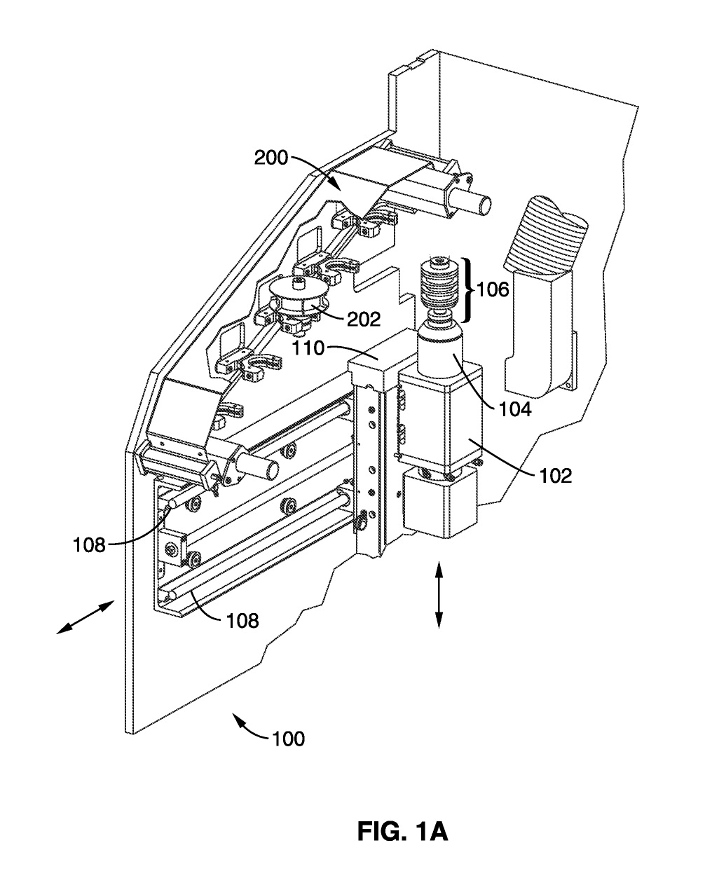

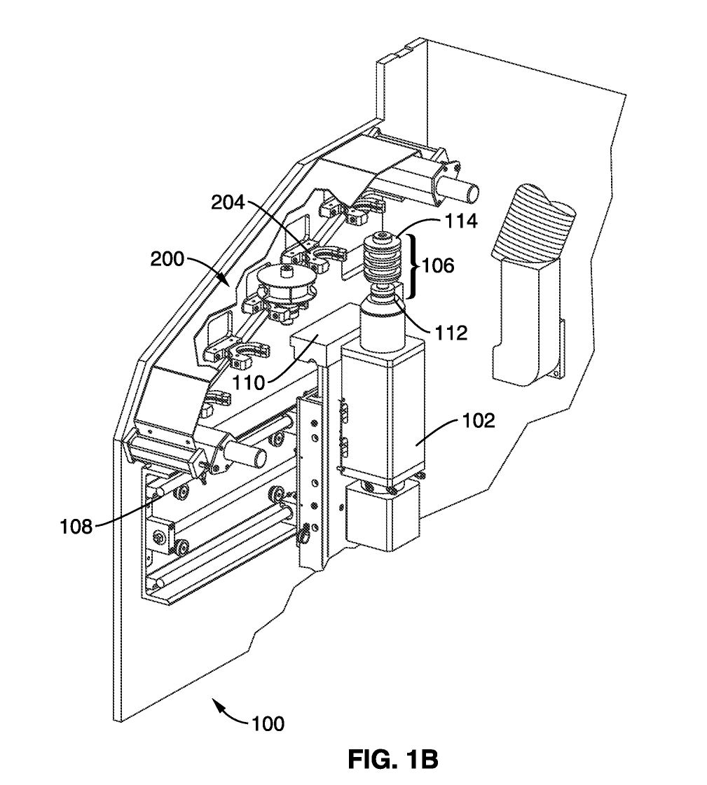

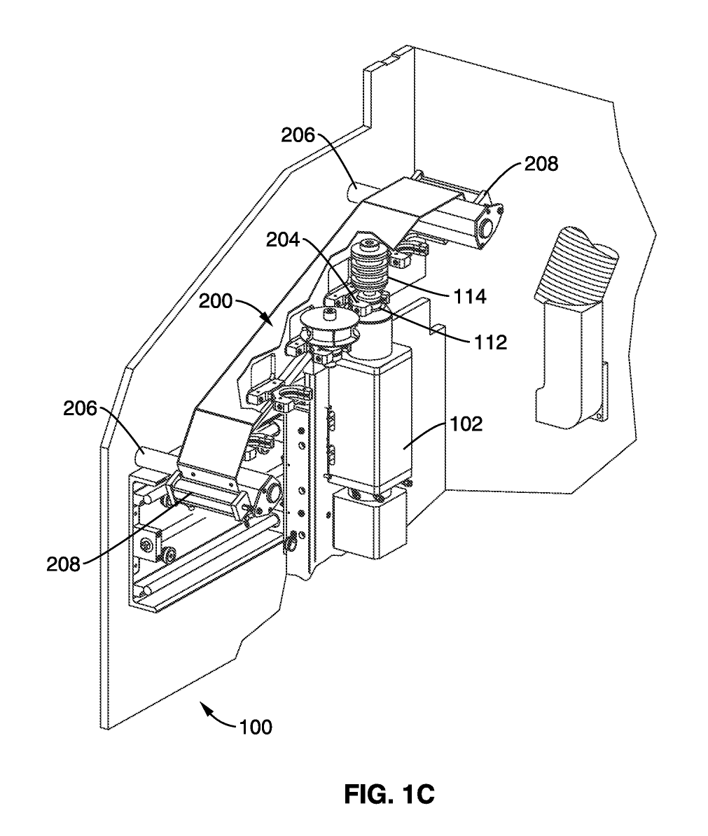

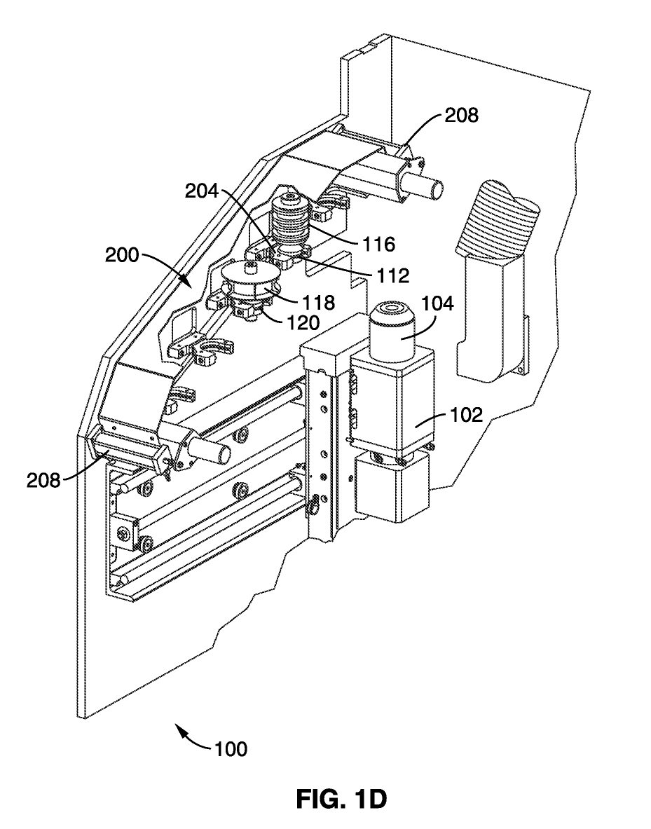

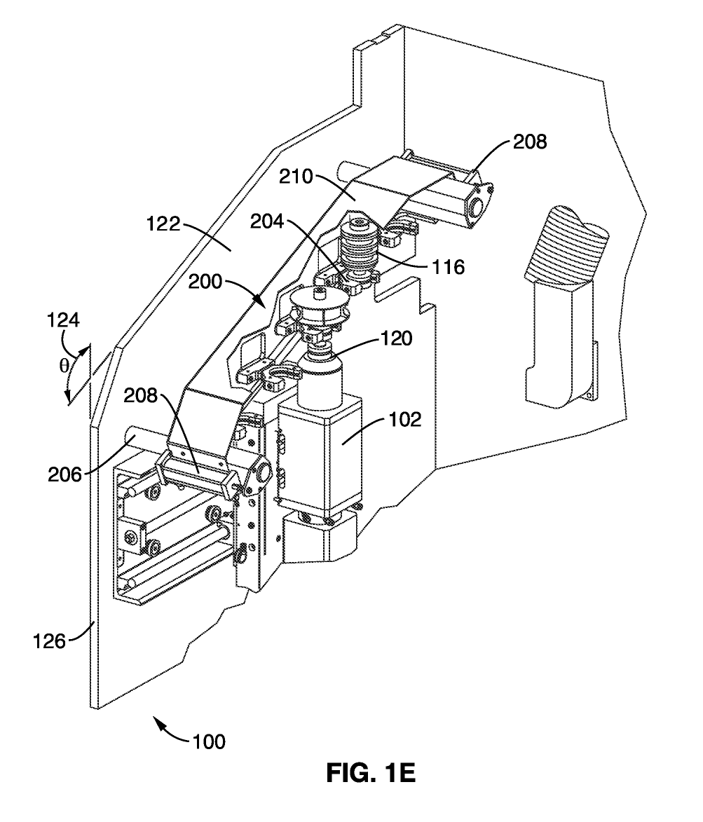

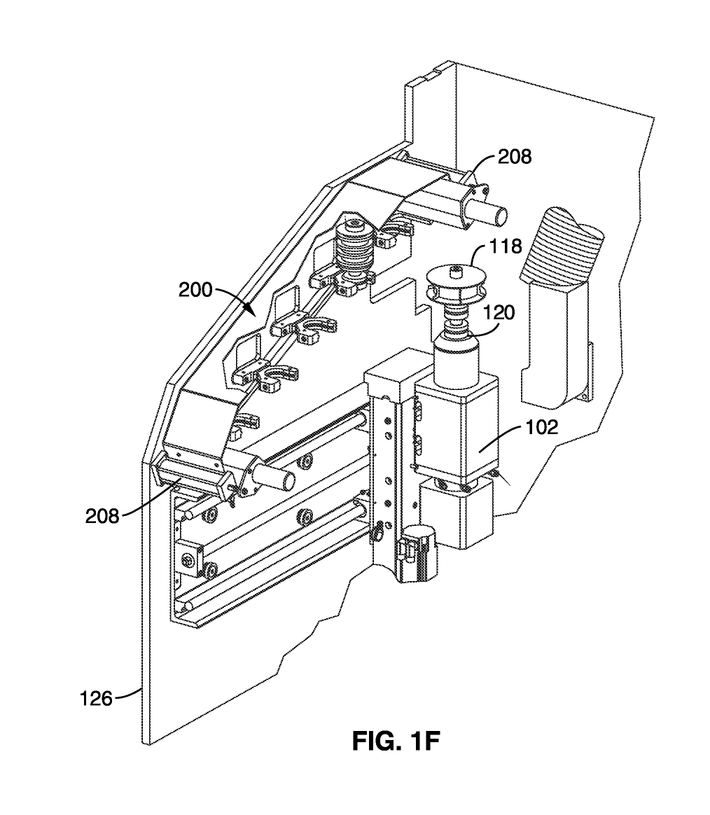

Referring more specifically to the drawings, for illustrative purposes the present invention is embodied in the apparatus generally shown in FIG. 1A through FIG. 5B. It will be appreciated that the apparatus may vary as to configuration and as to details of the parts, and that the method may vary as to the specific steps and sequence, without departing from the basic concepts as disclosed herein.

### Definitions

“Computer Numerical Control” or “CNC” means a computer numerically controlled milling machine, and refers specifically to a computer “controller” that reads G-code instructions and drives a machine tool, a powered mechanical device typically used to fabricate components by the selective removal of material. CNC does numerically directed interpolation of a cutting tool in the work envelope of a machine. The operating parameters of the CNC can be altered via a software load program.

“Machine Tool” means a tool used in the fabrication of shapes in a machining medium, such as wood, plastic, or metal. Examples of such machine tools include, without limitation: rotational cutters such as end mills, drills, shapers, saws, sanders, routers; reciprocating tools such as mortising tools, saws, shapers, and carvers. In the sense of this patent application, a machine tool is any tool that may be automatically mounted to a tool power source. A machine tool functions by removing material from a work piece in a controlled manner.

“Tool Holder” means an NMTB, HSK or other base to which machine tools are mounted to for use on an CNC machine.

“Tool Fork” means a device capable of holding a machine tool mounted on a tool holder. One example is a “U” shaped, two tined fork where tool holders nestle between the two tines for storage.

“Tool Repository” means a platform mounting a plurality of tool forks, so that a plurality of machine tools may be stored for use by a CNC spindle.

“Computer” means any device capable of performing the steps, methods, or producing signals as described herein, including but not limited to: a microprocessor, a microcontroller, a video processor, a digital state machine, a field programmable gate array (FGPA), a digital signal processor, a collocated integrated memory system with microprocessor and analog or digital output device, a distributed memory system with microprocessor and analog or digital output device connected by digital or analog signal protocols.

“Computer Readable Medium” means any source of organized information that may be processed by a computer to perform the steps described herein to result in, store, perform logical operations upon, or transmit, a flow or a signal flow, including but not limited to: random access memory (RAM), read only memory (ROM), a magnetically readable storage system; optically readable storage media such as punch cards or printed matter readable by direct methods or methods of optical character recognition; other optical storage media such as a compact disc (CD), a digital versatile disc (DVD), a rewritable CD and/or DVD; electrically readable media such as programmable read only memories (PROMs), electrically erasable programmable read only memories (EEPROMs), field programmable gate arrays (FGPAs), flash random access memory (flash RAM); and information transmitted by electromagnetic or optical methods including, but not limited to, wireless transmission, copper wires, and optical fibers.

### Introduction

In this application, one or more machine tools are held in a translating frame that simply translates in and out of a tool changing (or “staging”) position, where a CNC spindle may readily pick up or deposit a tool. The simplicity of the design leads to a very compact, high speed, low cost, and highly reliable method of tool changing.

One example of the translational tool changer is that of a CNC feed through shaper/sander, such as the Voorwood A1515 CNC Shaper/Sander, Voorwood Company, 2350 Barney Street, Anderson, Calif. 96007. For simplicity, the A1515 will be used as one example of the translational tool changer in the following description of one aspect of the invention. This Shaper/Sander generally works with hard and soft woods as an input material, but by modification of the machine tools and feed rates metals, plastics, and other machinable materials may also be used.

FIGS. 1A-F collectively depict a tool exchanging cycle. The details of the device, as well as the device interaction with the CNC machine, will be described in the individual drawings below.

Refer now to FIG. 1A, which is an angled perspective view of a translational tool changer within a feed through CNC device, collectively annotated as 100. In this view, a protective cover (described later) have been removed for clarity, as otherwise little of these interior views would be visible. A tool repository 200 is shown in its storage position. In this position, there is no possibility of interaction with the CNC motor 102, or rotating spindle 104, that receives an active machine tool 106. The CNC motor 102 is translated laterally on way bars 108 by a lead screw or other method, and vertically on a vertical stage 110. Since the machine tool 106 is attached to the CNC motor 102, it also is capable of the same lateral and vertical movements as the CNC spindle 104.

In this particular embodiment, the CNC motor 102 and an active machine tool 106 are only capable of planar motion, or two degrees of freedom. This is characteristic of a feed through machine, capable of machining work pieces of arbitrarily length. However, the methods and apparatus taught here are readily applicable to other multi-axis CNC machines having 3, 4, or more degrees of freedom.

In this particular CNC apparatus, there is no possibility of the CNC machine 100 directly exchanging a stored machine tool 202 resident in the tool repository 200, absent motion by the tool repository 200. Therefore, in this CNC machine 100, the tool repository 200 must move to allow for tool storage and exchange.

In FIG. 1B, the CNC motor 102 has translated laterally to a position that will later align with an opening of a tool fork 204. This position may be referred to as a staging position. This movement may also have included a vertical translation of the CNC motor 102, where the vertical stage 110 has moved vertically upward. These motions are designed so as to align the tool fork 204 opening with the active machine tool 106 tool holder 112 that mounts the machine tool 114 to the CNC spindle 104.

In FIG. 1C, the tool repository 200 has translated out on slide rods 206 through the operation of pneumatic actuators 208. In this actuated position, the opening of one of the tool forks 204 has received the tool holder 112 holding machine tool 114. At this point the rotating spindle 104 releases the tool holder 112, allowing for the CNC motor 102 to lower, and completely disconnect from the previous machine tool 114.

In FIG. 1D, the CNC motor has deposited the initial tool 114 by depositing the initial tool 114 tool holder 112 into a first tool fork 204. Here, the CNC motor 102 is moved back for clarity to show that now two tools, 114 and 118 are stored in the repository. In this view, the tool repository 200 has been shown retracted to its storage position. Generally, this particular state is never needed, as tools may be exchanged without this step. This figure has only been shown to clarify the motions capable of the invention during the tool changing sequence of operations.

In FIG. 1E, the CNC motor 102 has repositioned both vertically and laterally to mount a new machine tool 118 mounted on its tool holder 120. Here, the CNC support wall 122 is seen, now that the tool repository 200 (not labeled here), has no longer been blocked from view by the tool repository 200 cover 210. The cover 210 protects users from the sharp edges of machine tools, e.g. 116, stored within the tool repository 200.

The CNC support wall 122 and the tool repository 200 are angled 124 with respect to the front edge 126 of the support wall 122 forming an angle θ. This allows room for the CNC motor 102 to be more closely positioned to a work piece (not shown), allows for easier operator viewing of the machine tool 106 as it interacts with the work piece, and minimized the size, cost, and weight of the resultant CNC machine 100. Angle θ may range from 10 to 80 degrees, however is increasingly useful in the 30 to 60 degree range to minimize the CNC machine 100 footprint.

Still another reason for the angled front wall is that the lowest stored machine tool is utilizing the space behind the CNC motor 102. This area would be wasted otherwise. As the tool changer front wall angles upward, it opens up the area allowed for the spindle to cut. This angle in the tool changer also makes the CNC machine 100 doors easier to manufacture, as they are simple bends with considerable resulting stiffness in the door assembly (not shown).

In FIG. 1F, the CNC motor 102 has returned to a working position with the new active machine tool 118 mounted on its own separate tool holder 120. The tool repository 200 has also translated back to its resting position.

Altogether, the sequence of operations required to exchange an initial active machine tool 106 for a stored machine tool 202, although somewhat complicated to explain in detail, may require only about 40 seconds. The sequence may be speeded up by increasing accelerations of the CNC motor 102 motions, as well as the translation of the tool repository 200.

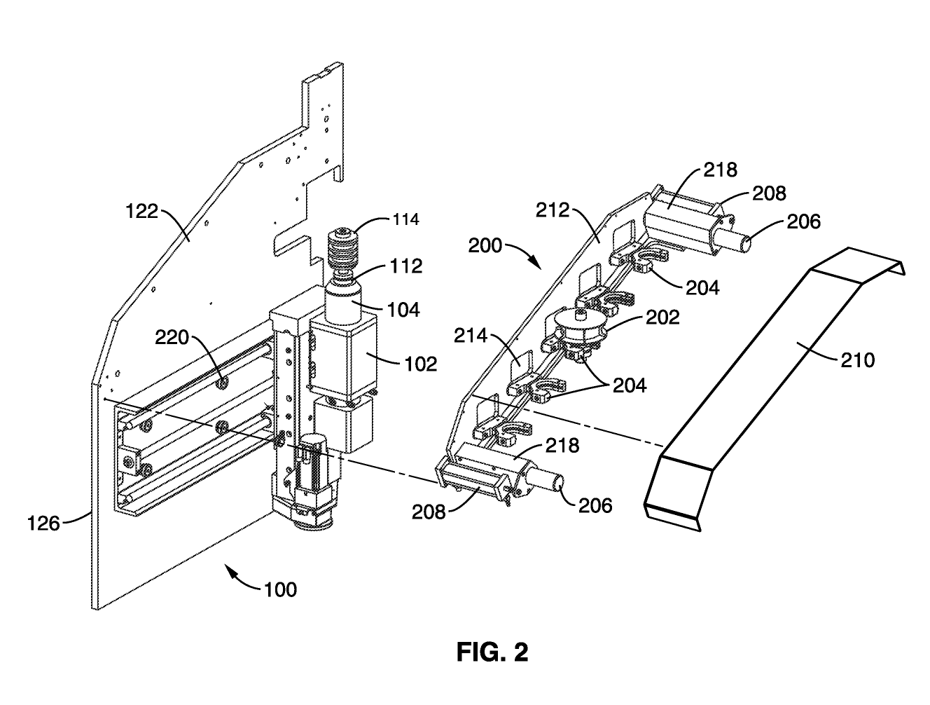

Refer now to FIG. 2, which shows a more detailed exploded assembly view of the tool repository 200 separated from the CNC machine 100 support wall 122. Additionally, the tool repository 200 cover 210 has been exploded to better show the functional components of the tool repository 200. The tool repository 200 cover 210 has an important function of protecting users from sharp machine tools stored in the tool repository 200, it additionally adds rigidity to the tool repository 200 structure.

The tool repository 200 comprises a tool changer frame 212, where a plurality of tool forks 204 is mounted. In this embodiment of the invention, there are five tool forks 204, although there could be designed fewer or greater numbers of tool forks 204. With suitable sizing and redesign of the tool changing frame 212 and tool forks 204, up to 15 machine tools with a 1½ inch diameter are able to be stored in the same space. Due to the potential radial size of a machine tool 202, there are relief ports 214, where material has been removed from the tool changer frame 212. This allows for greater radial machine tool 202 size as well as a more compact tool repository 200, where a machine tool 202 might otherwise mechanically interfere with the surface plane of the tool changer frame 212. With the relief ports 214, cutting tools in one embodiment have dimensions as much as 5 inches high, with a diameter as large as of 8 inches. Suitable straightforward redesigns would allow for arbitrarily large or small machine tools 202.

The tool changer frame 212 translates upon slide rods 216 disposed at either end of the tool changer frame 212. These slide rods 216 are mounted in turn to the CNC support wall 122. Two pneumatic actuators 208 are respectively attached to slide blocks 218, and cause translational sliding of the slide blocks 218, the tool changer frame 212 to which they are attached, all of the tool forks 204, and any machine tools 202 present.

The slide blocks 220 translate upon the slide rods 216 and, due to attachments to the tool changer frame 212, cause the tool changer frame 212 to translate when the slide blocks 220 are acted upon by the pneumatic actuators 218. These pneumatic actuators 218 bear upon the CNC support wall 122, and have a limited stroke in and out. The pneumatic actuators 218 result in precisely controlled actuation out and back of the tool repository 200 to very repeatable, high accuracy positioning.

The tool changer frame 212 is controlled with pneumatic actuators 208 that allow it to move horizontally to position itself over the CNC spindle 104 and then move back so as to not interfere with the machining process.

It has frequently been found in the art of mechanical design that pneumatic actuators are extremely reliable, inexpensive, and may be chosen with arbitrarily large actuation forces and/or strokes. That said, while pneumatic actuators 208 are used here, other forms of actuation may be used as well, such as lead screw, linear stepper motor, and the like without limitation. Further, while air is used here as the pneumatic actuation fluid, alternative fluids such as cutting fluids, synthetic or natural hydrocarbon oils, and others may also be used without limitation.

The benefit of this smaller, straight tool changer frame 212 design is that it allows the overall wood working CNC machine 100 to be considerably smaller and more compact while still having the same capabilities as other machines of this type. As mentioned, this design is also considerably less expensive and easier to manufacture than the traditional turret design because it utilizes pneumatic cylinders for the positioning of the tool changer frame 212 instead of DC servomotors or stepper motors with their ancillary required circuitry and power supplies.

Like most pneumatic actuators, one simple arrangement of two ports serves to actuate out, and reversal of pressures upon the two ports serves to actuate back. Alternatively, the actuator may comprise a pressure supplied to a single port, where either the return or actuation motion depends upon a spring being compressed or extended.

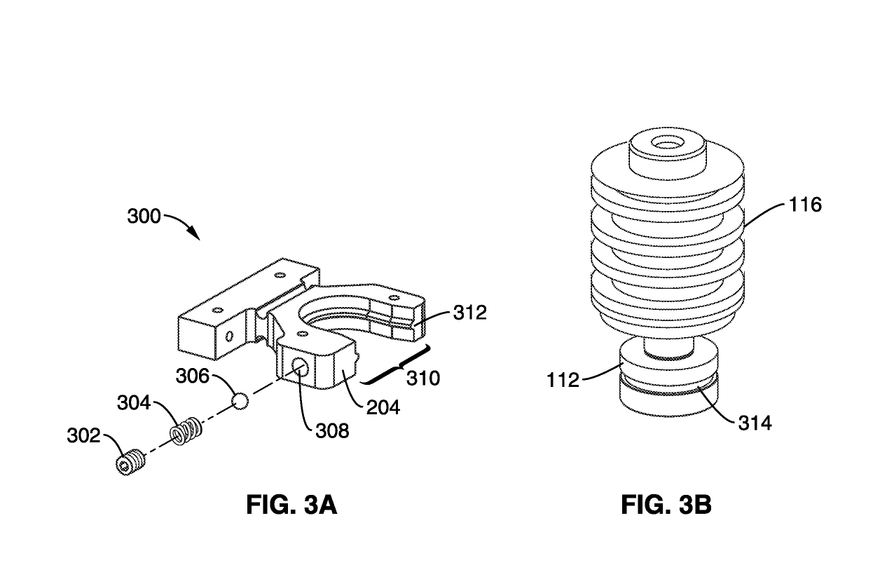

Each tool fork 204 engages a matching groove in the tool holder 112 to store the machine tool 202, as further described in FIGS. 3A and 3B.

Refer now to FIG. 3A, which is a detailed assembly perspective view of the tool fork 204 assembly details 300. Here a set screw 302 retains a retention spring 304 that presses upon a ½ inch steel ball bearing 306. This all is placed into recess 308 of the tool fork 204 body. The recess 308 has been machined with a ball end mill, resulting in a small amount of projection (not shown in this view) of the ½ inch steel ball bearing 306 into the tool holder receiving area 310.

Now referring to FIGS. 3A and 3B together, the small projection of the steel ball bearing 306 allows the spring loaded motion to retain a tool holder 112, and the results in the removable retention of the machine tool 116. A male (raised) groove 312 in the tool fork 204 couples with a mating female (recessed) groove 314 in the tool holder 112. In operation, the tool holder 112 is removably stored in tool fork 204, and retained by the ½ inch steel ball bearing 306.

The tool holder 112 serves as a removable mount for a machine tool 116. Depending on the type of rotary spindle 104 (of FIG. 1A), the CNC machines 100 (of FIGS. 1A-1F) are capable of accepting National Machine Tool Builders (NMTB), NMT, NT, or HSK tapers.

The standard 3.5 in. per ft. NMTB tapers are also known as NMT, NT, MM, and NMM tapers. Hollow shank tooling (HSK) mounts are designed to increase spindle-tool holder grip as spindle speed increases. Both NMTB and HSK are commonly used in the CNC industry for automatic tool changing.

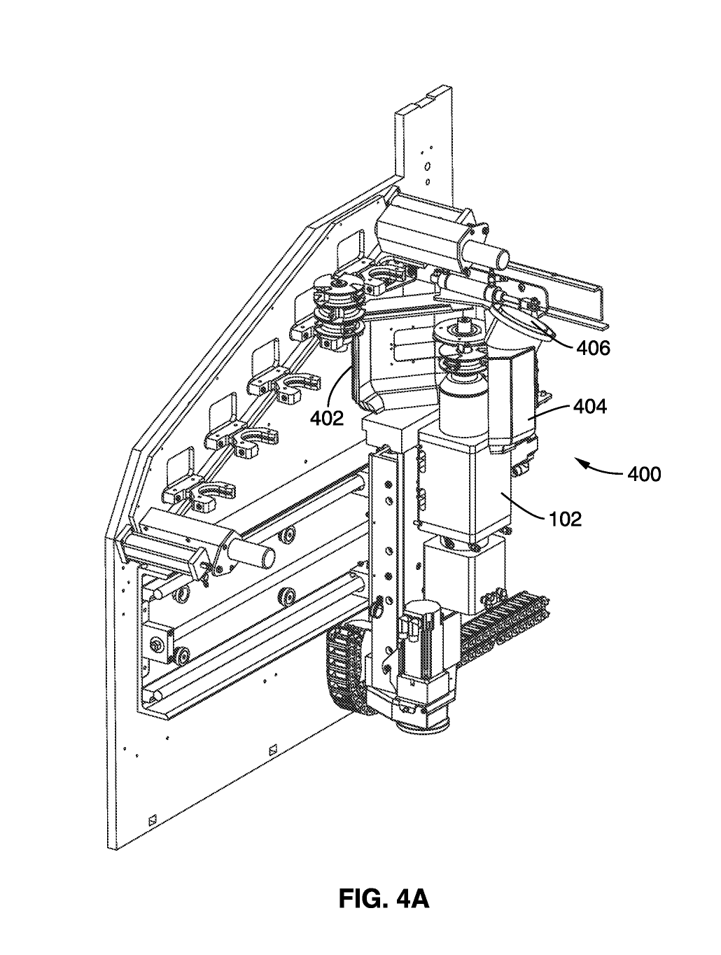

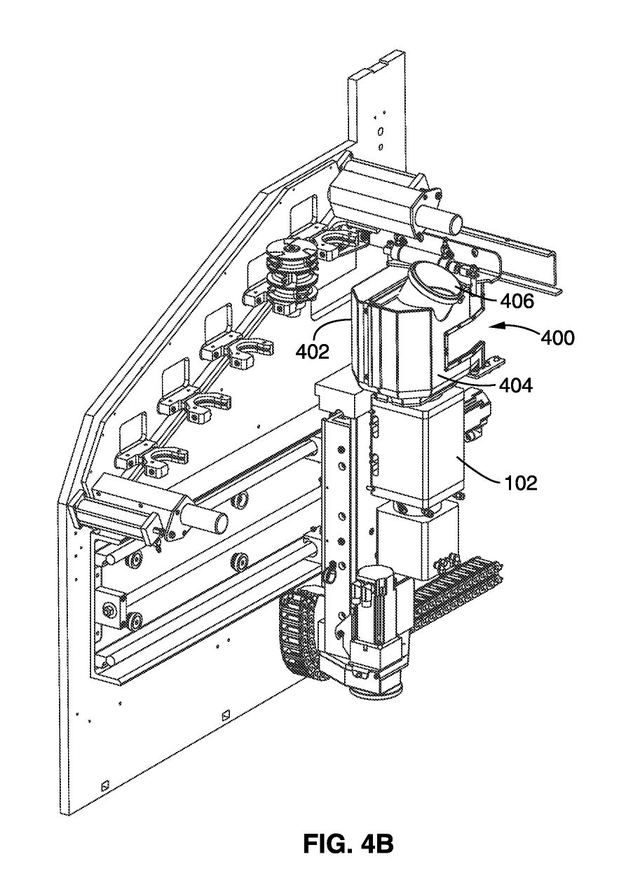

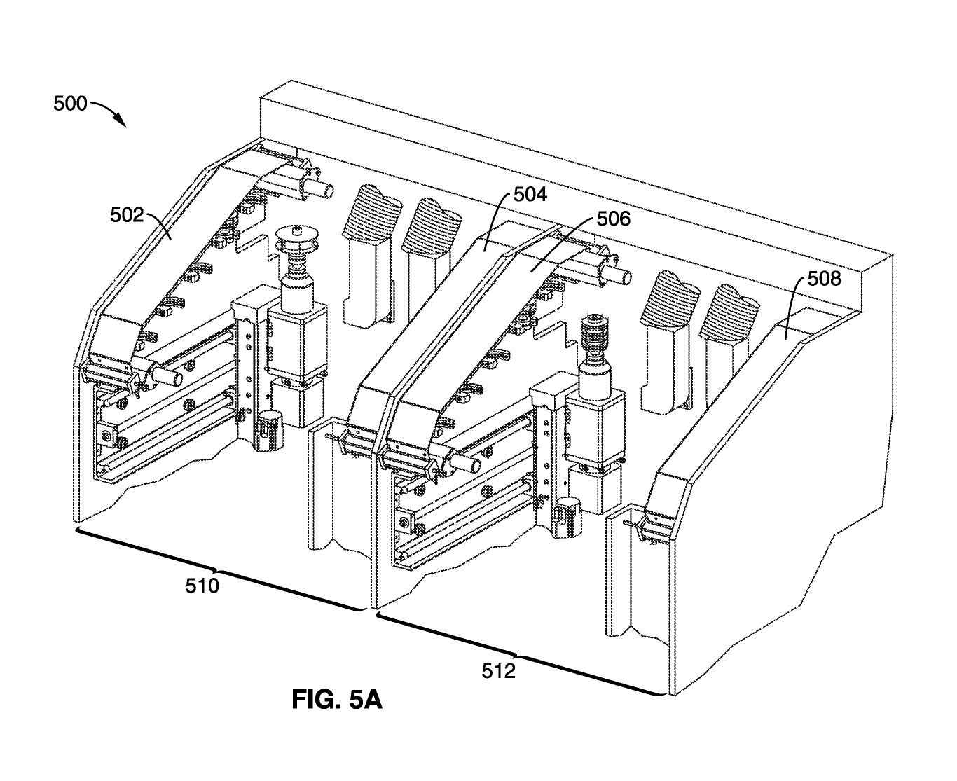

Refer now to FIGS. 4A and 4B to better highlight the operation of the dust collection system 400. In FIG. 4A, a left dust collector 402 and a right dust collector 404 pivot about a common point (not shown). Right dust collector 404 has an attachment point 406 to a flexible dust collector hose (not shown here). The dust collection system opens when the CNC motor 102 needs to be removed for tool changing or other operations.

In FIG. 4B, the dust collection system 400 is shown closed. Here, the left dust collector 402 and a right dust collector 404 have pivoted about a common point (not shown) so as to be closed. Right dust collector 404 has an attachment point 406 to a flexible dust collector hose (not shown here), and in the closing operation, the dust collector hose (not shown) has compliantly moved to continue vacuuming any dust or cuttings from the operation of the cutting tool (not visible here) carried by the CNC motor 102.

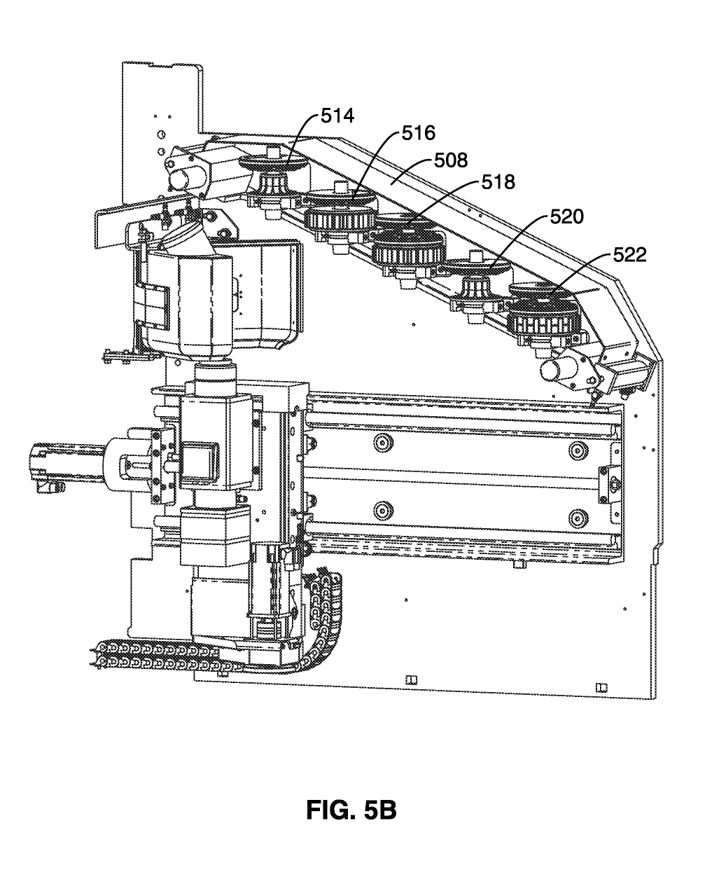

Refer now to FIG. 5A, which is a perspective view of a translational tool changer 500 integrated within the Voorwood A1515 CNC Shaper/Sander, from the Voorwood Company, 2350 Barney Street, Anderson, Calif. 96007. In this view, there are four tool repositories 502, 504, 506, and 508, of which 502 and 504 are disposed within a first work bay 510, and repositories 506 and 508 are disposed within a second work bay 512. The tool repository 502 and 506 may either be identical, or may have differences relating to the size of tools, number of tool forks, etc. Generally speaking, tool repository 504 actuates in the same direction but opposite manner as that of tool repository 502.

Similarly with the second work bay 512, tool repository 506 and 508 may either be identical, or may have differences relating to the size of tools, number of tool forks, etc. Generally speaking, tool repository 508 actuates in the same direction but opposite direction as that of tool repository 506. These tool repositories 506 and 508 may either be identical, or may have differences relating to the size of tools, number of tool forks, etc. relative to tool repositories 502 and 504.

Referring now to both FIGS. 5A and 5B, we find that, as an example, tool repository 508 may contain five different sanders/shapers, or other types of tools. These tools are, from top to bottom, 514, 516, 518, 520, and 522. Note that in FIG. 5B a separate CNC motor is present, thus in the Voorwood A1515 CNC Shaper/Sander, there are four CNC motors present.

Not shown in this application are the CNC machine controllers, cabling, dust collection vacuum motor and associated system, working pieces, or other equipment frequently present in CNC machinery, but not necessary to the understanding of this invention. It is to be understood that a computer controller will be used with suitable user computer readable media input/output device(s) to keep track of the contents of the tool repositories, the current active machine tool, and programming for particular cutting parameters for a given work piece to produce a processed (in this example of the A1515 a shaped and sanded) work piece.

It is to be specifically understood that the actuation of any tool repository will result in a specific translation, which may be programmed into the CNC machine so as to allow tool mounting, demounting, and/or machine tool exchange. Such programming may be used to sequence through the steps described in FIGS. 1A-1F, and may be stored on a computer readable memory.

In particular, this invention provides an automatic tool changer for the woodworking industry, which is simple in construction, reliable in operation, and more cost effective to manufacture.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A tool changer, comprising:
a CNC machine comprising a spindle;
a tool repository, comprising a plurality of tool forks;
one or more machine tools held by corresponding tool forks; and
means for transferring a specified tool between one of the tool forks and the spindle.

2. The tool changer of claim 1, wherein the means for transferring the specified tool comprises:
a slider rod mounted on one end to the CNC machine;
a slider block that translates on the slider rod;
wherein the slider block and the tool forks are affixed to a tool changer frame; and
an actuator that has attachment points to the CNC machine and to the slider block, that allows translational actuation of the tool changer frame relative to the CNC machine.

3. The tool changer of claim 2, further comprising:
two spaced apart slider blocks affixed to the tool changer frame, thereby preventing rotation of the tool changer frame.

4. The tool changer of claim 2, wherein the plurality of tool forks are disposed along the tool changer frame in a substantially linear fashion.

5. The tool changer of claim 1, wherein the tool fork comprises a spring loaded ball partially protruding into a tool holder receiving area.

6. The tool changer of claim 1, wherein the tool fork comprises a groove in a tool holder receiving area that mates with a corresponding ridge in the tool fork.

7. The tool changer of claim 1, wherein the tool fork comprises a ridge in a tool holder receiving area that mates with a corresponding groove in the tool fork.

8. The tool changer of claim 1, wherein the slider block comprises a translation with a possibility of rotation.

9. The tool changer of claim 1, wherein the slider block comprises a translation with substantially no possibility of rotation.

10. The tool changer of claim 1, wherein the tool changer is angled relative to a front wall of the tool changer with an angle selected from a set of angles comprising: 10 to 90 degrees, 20 to 80 degrees, 30 to 60 degrees, and 40 to 50 degrees.

11. The tool changer of claim 1, wherein the CNC machine has axes of motion of a rotary spindle selected from a group of axes consisting of: 2 axes, 3 axes, 4 axes, 5 axes, 6 axes, and more than 6 axes.

12. A method of tool changing, comprising:
providing a translating tool changing assembly, comprising: one or more tool forks mounted to a tool changing frame;
actuating the translating tool changing assembly causing one of the tool forks to move out to a staging translation position; and
moving the CNC motor, comprising a rotary spindle, thereby removably engaging a tool holder within a tool fork, forming an engagement.

13. The method of tool changing of claim 12, wherein the engagement comprises a mechanical feature in the tool holder and a matching mechanical feature in the tool fork.

14. The method of tool changing of claim 13:
wherein the mechanical feature in the tool holder is a recess forming a groove; and
wherein the mechanical feature in the tool fork is a ridge.

15. The method of tool changing of claim 13:
wherein the mechanical feature in the tool holder is a ridge; and
wherein the mechanical feature in the tool fork is a recess forming a groove.

16. The method of tool changing of claim 12, further comprising:
releasing the tool holder from the spindle;
moving the spindle away from the tool holder; and
retracting the translating tool changing assembly causing the tool forks to move to a storage location, thereby storing the tool in the tool changing assembly.

17. The method of tool changing of claim 12, further comprising:
retaining the tool holder to the spindle;
moving the spindle away from the tool fork; and
retracting the translating tool changing assembly causing the tool forks to move to a storage location, thereby loading the machine tool onto the spindle to form a loaded spindle.

18. The method of tool changing of claim 17, further comprising:
moving the loaded spindle to a working location; and
continuing CNC machining operations with the loaded spindle.

19. The method of tool changing of claim 12, wherein the tool holder is capable of mounting a machine tool on the rotary spindle.

20. An apparatus capable of performing the steps of claim 12.

21. A product produced by the process of claim 12.

22. A computer readable medium comprising a programming executable capable of performing on a computer the method of claim 12.
